(19) United States
(12) Patent Application Publication
(10) Pub. No.: US 2006/0226704 A1
(43) Pub. Date: Oct. 12, 2006

(54) Load drive apparatus and method

(75) Inventor: Naoya Tsuchiya, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/396,714

(22) Filed: Apr. 4, 2006

(30) Foreign Application Priority Data
Apr. 6, 2005 (JP) 2005-110076

(51) Int. Cl. H02J 3/14

(52) U.S. Cl. 307/32

(57) ABSTRACT

A load drive apparatus includes a drive signal control circuit for generating multiple drive signals, each of which is provided to each of the loads. The drive signal control circuit changes a phase of the drive signals in accordance with the number of the loads to equalize a phase difference between each of the drive signals. Therefore, it is less likely that all the loads are simultaneously driven. A concentrated increase in a load current can be prevented so that an increase in peak values of noise and heat production can be prevented.

### CROSS REFERENCE TO RELATED APPLICATION

This application is based on and incorporates herein by reference Japanese Patent Application No. 2005-110076 filed on Apr. 6, 2005.

### FIELD OF THE INVENTION

The present invention relates to a load drive apparatus and method for driving multiple electric loads.

### BACKGROUND OF THE INVENTION

As a load drive apparatus, a circuit configuration for driving multiple electric loads with pulse-width modulation (PWM) signals is proposed as shown in FIG. 9.

In the configuration, a central processing unit (CPU) 1 outputs duty signals D_{A}-D_{C} corresponding to target current values of respective electric loads 7A-7C to a control circuit 2. The control circuit 2 generates PWM signals P_{A}-P_{C} based on the duty signals D_{A}-D_{C}, respectively, and outputs the PWM signals P_{A}-P_{C} to load drive circuits 3A-3C corresponding to the loads 7A-7C, respectively. Each of the load drive circuits 3A-3C includes a drive circuit 4 and a load current detection circuit 5. The drive circuit 4 allows a power source 6 to supply a load current to each of the loads 7A-7C in accordance with each of the PWM signals P_{A}-P_{C}. The load current detection circuit 5 detects the load current and outputs each of current detection signals I_{A}-I_{C}to the control circuit 2.

For example, the loads 7A-7C may be linear solenoids for driving a hydraulic control valve that maintains a line pressure (e.g., a braking liquid pressure for an anti-skid control and a transmission liquid pressure for an automatic transmission control) at a predetermined working pressure level.

The control circuit 2 is constructed as shown in FIG. 10. The duty signals D_{A}-D_{C} output from the CPU 1 are provided to calculation circuits 8A-8C, respectively. The calculation circuits 8A-8C output PWM command signals PC_{A}-PC_{C} to non-inverting inputs of comparators 9A-9C, respectively. The PWM command signals PC_{A}-PC_{C} have amplitudes corresponding to differences between the duty signals D_{A}-D_{C} and the current detection signals I_{A}-I_{C}, respectively. A waveform generator 10 outputs a triangular wave signal to inverting inputs of the comparators 9A-9C. The triangular wave signal is used as a carrier of the PMW signals P_{A}-P_{C} The comparators 9A-9C compare the amplitudes of the PWM command signals PC_{A}-PC_{C} with that of the triangular wave signal and outputs the PWM signals P_{A}-P_{C} based on the results of the comparisons, respectively.

Specifically, the control circuit 2 generates the PWM signals P_{A}-P_{C} as shown in FIG. 11. Each of the PWM command signals PC_{A}-PC_{C} is compared with the same triangular wave signal. Therefore, although each of the PWM command signals PC_{A}-PC_{C} has different amplitude, there is a period of time when all the three loads 7A-7C are simultaneously energized and driven. Accordingly, peak values of noise and heat production in the load drive apparatus may be increased.

The control circuit 2 may be modified as shown in FIG. 12, in which a control circuit 2A includes waveform generators 10A-10C provided to the comparators 9A-9C, respectively. In the control circuit 2A, triangle wave signals provided from the waveform generators 10A-10C to the comparators 9A-9C are asynchronous to one another. Such an approach may prevent all the three loads 7A-7C from being simultaneously energized and driven. However, the approach makes circuit configuration of the control circuit 2A redundant and it is impossible to understand what timing each of the loads 7A-7C is driven at, unless the control circuit 2A is actually operated.

### SUMMARY OF THE INVENTION

In view of the above-described problem, it is an object of the present invention to provide a load drive apparatus and method for driving multiple electric loads without a concentrated increase in a load current.

A load drive apparatus includes a drive signal control circuit for generating multiple drive signals to drive multiple electric loads, each of which is provided to each of the loads. The drive signal control circuit changes a phase of the drive signals in such a manner that it is less likely that all the loads are simultaneously driven. Thus, a concentrated increase in a load current can be prevented so that an increase in peak values of noise and heat production can be prevented.

### BRIEF DESCRIPTION OF THE DRAWINGS

The above and other objectives, features and advantages of the present invention will become more apparent from the following detailed description made with reference to the accompanying drawings. In the drawings:

FIG. 1 is a circuit diagram of a drive signal control circuit of a load drive apparatus according to a first embodiment of the present invention;

FIG. 2 is a timing diagram of the drive signal control circuit of FIG. 1;

FIG. 3 is a circuit diagram of a drive signal control circuit of a load drive apparatus according to a second embodiment of the present invention;

FIG. 4 is a circuit diagram of a drive signal control circuit of a load drive apparatus according to a third embodiment of the present invention;

FIGS. 5A and 5B are circuit diagrams of an inverting circuit used in the third embodiment;

FIG. 6 is a timing diagram of the drive signal control circuit of FIG. 4;

FIG. 7 is a circuit diagram of a load drive apparatus according to a first application of the present invention;

FIG. 8 is a circuit diagram of a load drive apparatus according to a second application of the present invention;

FIG. 9 is a circuit diagram of a load drive apparatus according to a related art;

FIG. 10 is a circuit diagram of a control circuit of FIG. 9;

FIG. 11 is a timing diagram of the control circuit of FIG. 10; and

FIG. 12 is a circuit diagram of a control circuit according to a modification of the control circuit of FIG. 10.

### DETAILED DESCRIPTION OF THE PREFERRED EMBODIMENT

### First Embodiment

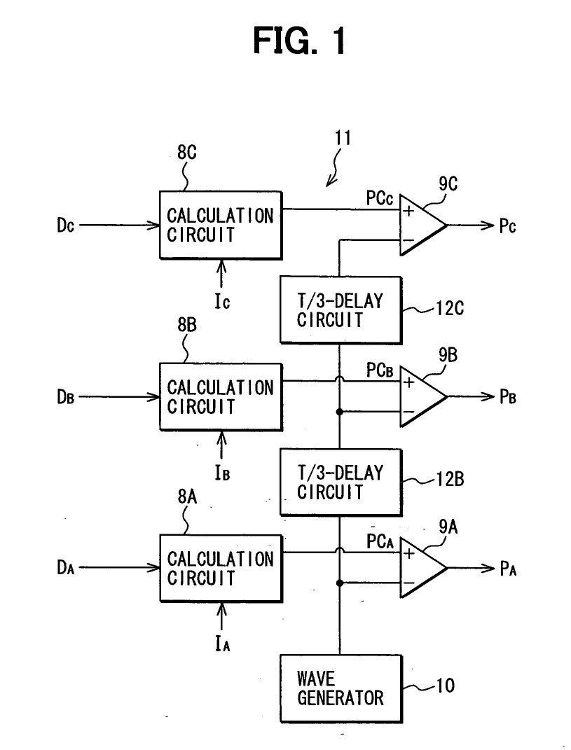

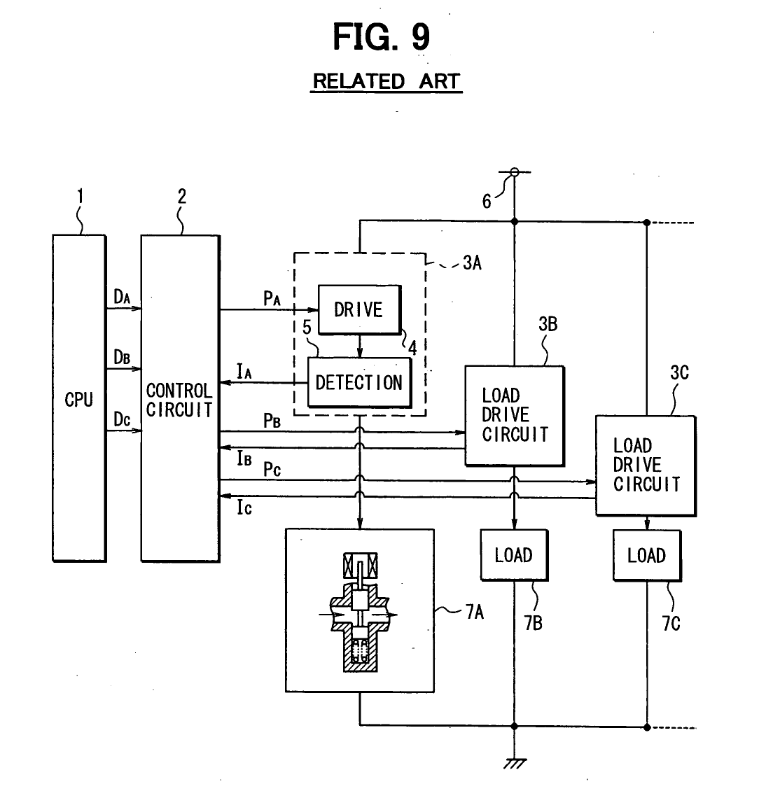

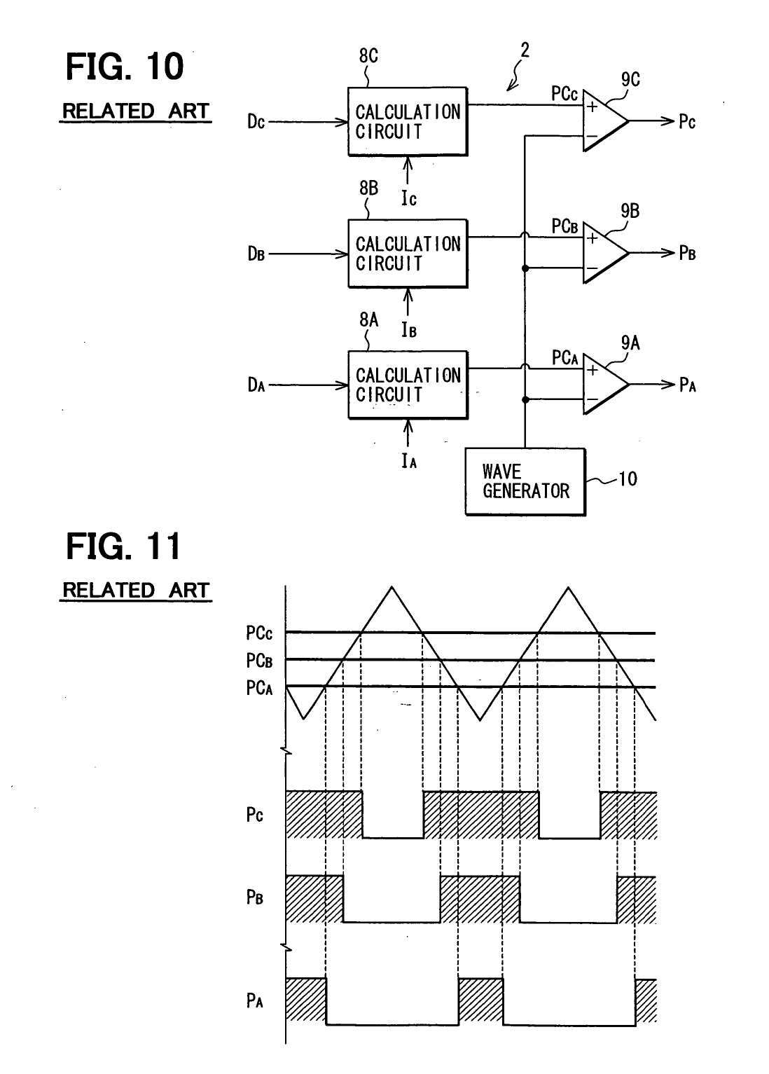

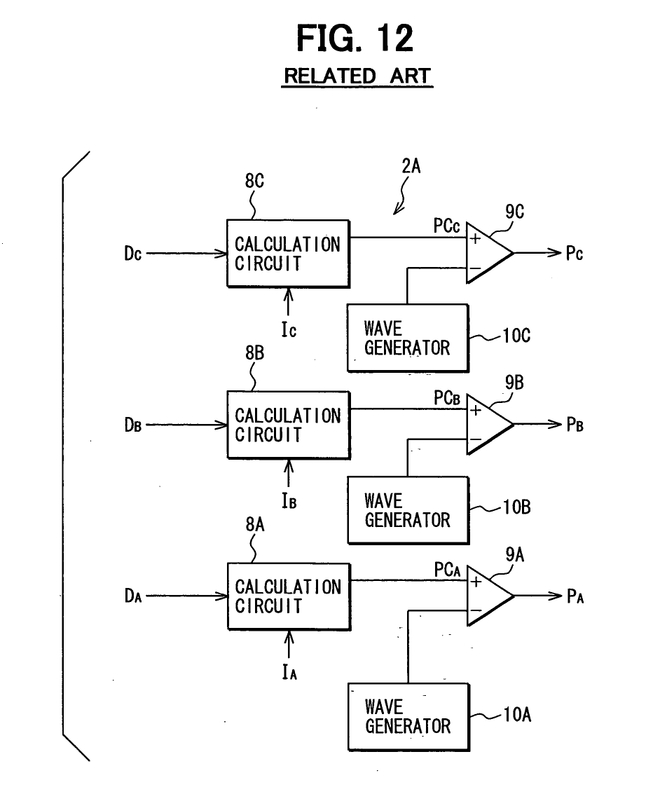

A control circuit 11 as a drive signal control circuit in a load drive apparatus will now be described with reference to FIGS. 1, 2 and 9. In the load drive apparatus of FIG. 9, the control circuit 11 is used in place of the control circuit 2. In embodiments described below, it is assumed that three loads 7A-7C are driven.

The control circuit 11 includes delay circuits 12B, 12C in addition to calculation circuits 8A-8C, comparators 9A-9C, and a waveform generator 10. The delay circuits 12B is inserted in series between the comparators 9A, 9B, and the delay circuits 12C is inserted in series between the comparators 9B, 9C. Each of the delay circuits 12B, 12C delays a phase of a carrier signal output from the waveform generator 10 by a value corresponding to one-third of a cycle period T of the carrier signal.

For example, when the carrier signal has a frequency of 300 Hz, the carrier signal has the cycle period T of about 3.33 milliseconds (ms). In this case, each of the delay circuits 12B, 12C is configured such that the carrier signal is delayed by 1.11 ms (i.e., T/3) when passing through each of the delay circuits 12B, 12C. In such a configuration, a carrier signal having no time delay, a carrier signal having a time delay of T/3, and a carrier signal having a time delay of 2T/3 are provided to the comparators 9A-9C, respectively.

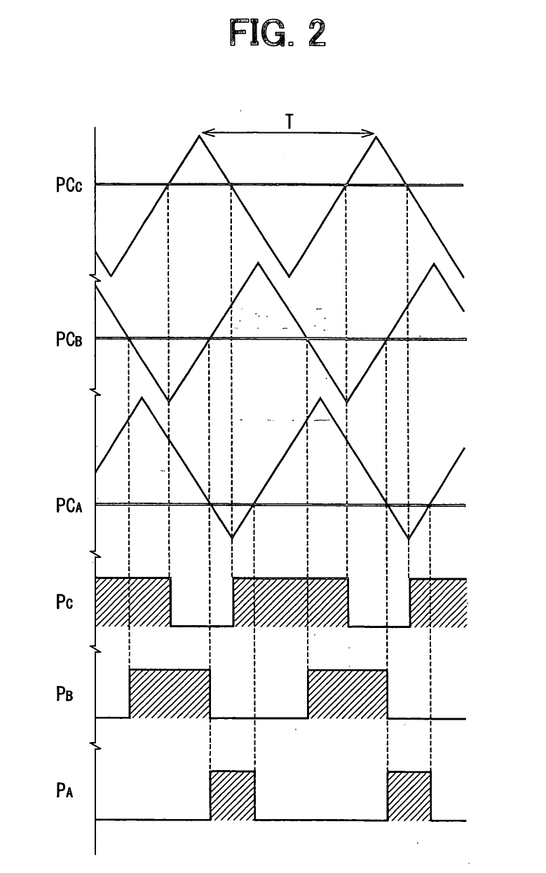

Thus, the PWM signals P_{A}-P_{C} provided to the loads 7A-7C are generated as shown in FIG. 2. In this case, one or two loads 7 are simultaneously energized, and therefore there is no period of time when all the three loads 7A-7C are simultaneously driven.

The control circuit 11 outputs the PWM signals P_{A}-P_{C} to the loads 7A-7C, respectively, in such a manner that it is less likely that all the three loads 7A-7C are simultaneously driven. Specifically, the carrier signal output from the waveform generator 10 is phase-shifted by T/3 when passing through each of the delay circuits 12B, 12C. Thus, the PWM signals P_{A}-P_{C} are equally phase-shifted in accordance with the number of the loads 7A-7C. In such an approach, each of the loads 7A-7C is driven at a different timing equally shifted from each other, and therefore it is less likely that all the three loads 7A-7C are simultaneously driven. Consequently, the concentrated increase in the load current can be prevented so that the increase in peak values of noise and heat production can be prevented.

Because the loads 7A-7C are driven by the PWM signals P_{A}-P_{C} energization and de-energization of the loads 7A-7C are very frequently repeated, and accordingly noise and heat production tend to be increased. Therefore, the present invention can be effectively applied to the load drive apparatus for driving multiple loads with PWM signals.

### Second Embodiment

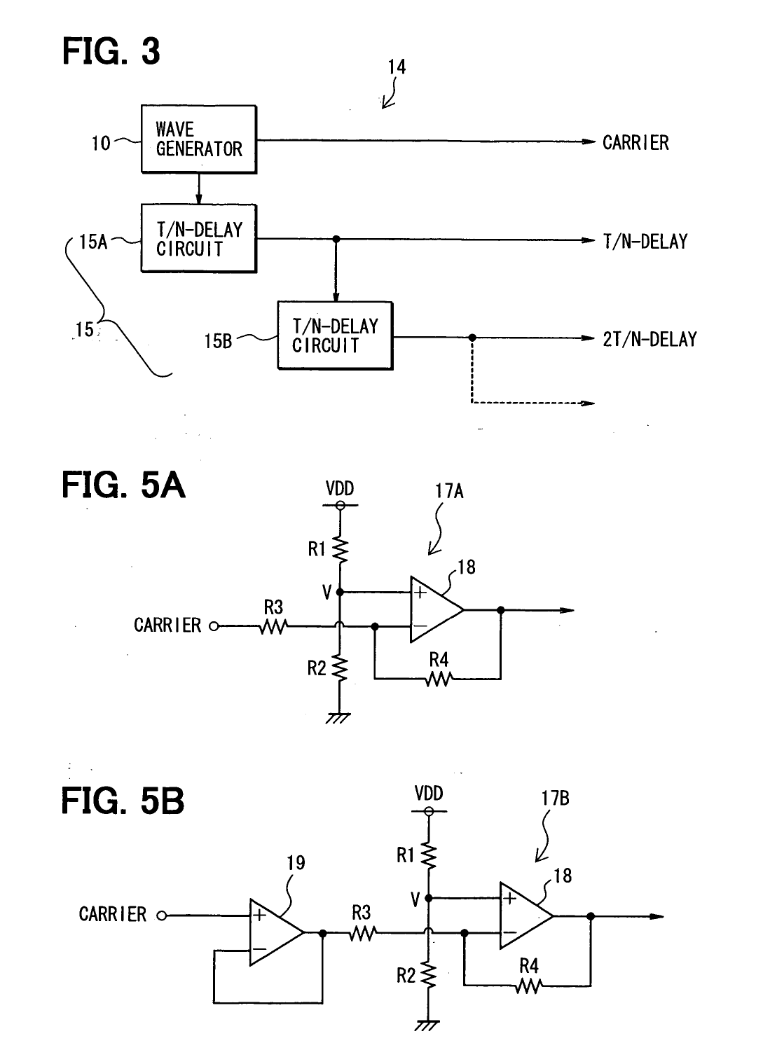

In the second embodiment, as shown in FIG. 3, a control circuit 14 is used for driving N loads in parallel, where N is a positive integer. In short, the control circuit 11 shown in FIG. 1 is generalized into the control circuit 14. The control circuit 14 includes N-1 delay circuits 15, each of which delays the phase of the carrier signal by T/N. The carrier signal output from the waveform generator 10 is delayed by T/N when passing through the first delay circuit 15A. Then the carrier signal having T/N -time delay is delayed by T/N when passing through the second delay circuit 15B. Therefore, the carrier signal having 2T/N time delay is output from the second delay circuit 15B. In such an approach, each of the N loads can be driven at a different timing equally shifted from each other.

### Third Embodiment

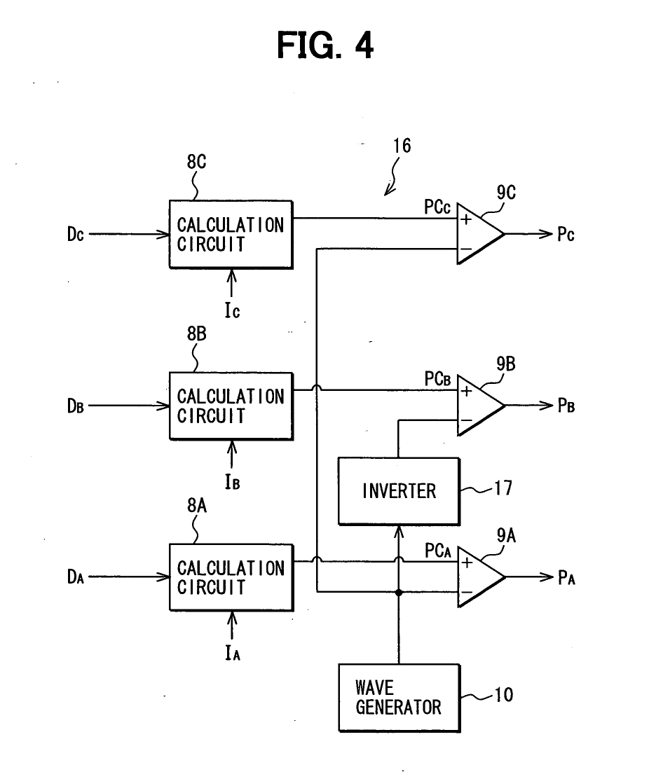

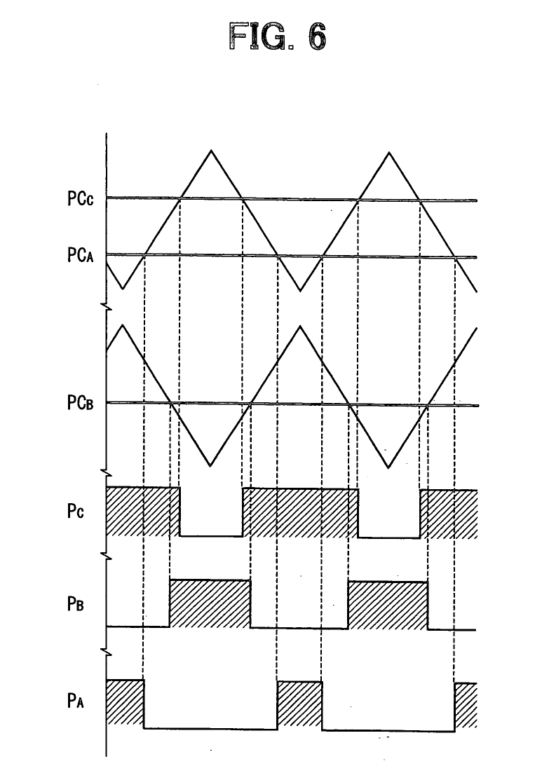

As the third embodiment, as shown in FIG. 4, a control circuit 16 includes an inverting circuit 17 for inverting the phase of the carrier signal, instead of the delay circuits 12B, 12C in the first embodiment (FIG. 1). The inverting circuit 17 is inserted between the comparators 9A, 9B. Therefore, as shown in FIG. 6, the carrier signal provided to the comparators 9A, 9C has a non-inverted phase and the carrier signal provided to the comparator 9B has an inverted phase.

The inverting circuit 17 may be constructed as an inverting circuit 17A shown in FIG. 5A. The inverting circuit 17A includes an operational amplifier 18 and resistors R1-R4. The resistors R1, R2 have the same resistance and the resistors R3, R4 have the same resistance. In this case, a voltage potential V applied to a non-inverting input of the operational amplifier 18 is given by the following equation:

$$V = \frac{R 2}{R 1 + R 2} {V}_{DD} = \frac{{V}_{DD}}{2}$$

In the equation, V_{DD} represents a power supply voltage. As can be understood from the equation, the voltage potential V is one-half of a peak-to-peak amplitude of the carrier signal. Thus, the amplitude of the carrier signal output from the waveform generator 10 is inverted by the inverting circuit 17A.

The inverting circuit 17A may work improperly, when the carrier signal output from the waveform generator 10 is distorted due to lack of power. To prevent the problem, the resistances of the resistors R1-R4 need to be increased. However, differences in resistance between the resistors R1, R2 and between the resistors R3, R4 are increased, as the resistances of the resistors R1-R4 are increased. Further, when thin-film resistors are used as the resistors R1-R4, sizes of the resistors R1-R4 need to be increased in order to allow the resistors R1-R4 to have high resistances and small differences in the resistances.

The inverting circuit 17 may alternatively be constructed as an inverting circuit 17B shown in FIG. 5B. In addition to the operational amplifier 18 and the resistors R1-R4, the inverting circuit 17B includes a buffer circuit 19 inserted between the waveform generator 10 and the operational amplifier 18. The buffer circuit 19 prevents the signal distortion without the increase in the resistances of the resistors R1-R4.

In this embodiment, the PWM signals P_{A}-P_{C} are generated by the control circuit 16. Because the carrier signal provided to the comparator 9B has the inverted phase with respect to those of the carrier signals provided to the comparators 9A, 9C, a period during which the load 7B is driven has an inverted phase with respect to those of periods during which the loads 7A, 7C are driven. Therefore, the load 7B is driven mainly during the period when the loads 7A, 7C are not driven, and there is no period of time when all the three loads 7A-7C are simultaneously driven.

In the control circuit 16, at least one of the PWM signals P_{A}-P_{C} is generated based on the carrier signal inverted by the inverting circuit 17. Thus, it is less likely that all the three loads 7A-7C are simultaneously driven.

(First Application)

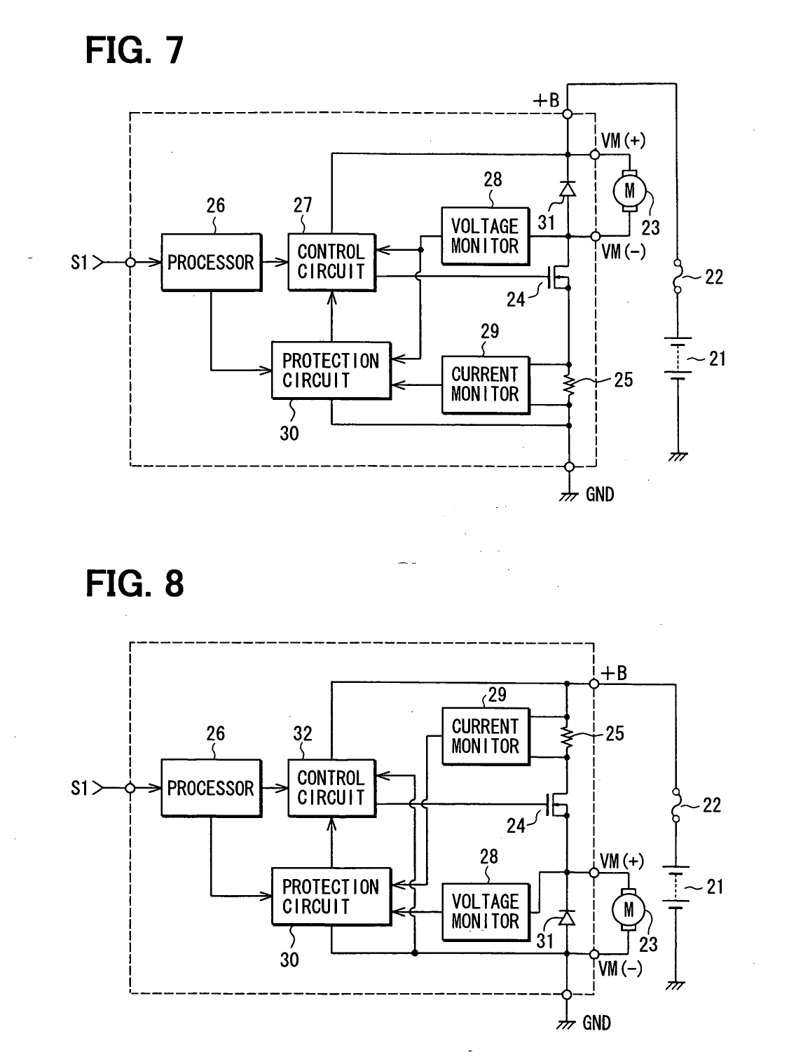

As the first application of the above embodiments, as shown in FIG. 7, a control circuit 27 is used for driving a direct current (DC) motor 23 mounted to a vehicle. A series circuit including a fuse 22, a DC motor 23, a N-channel power metal oxide semiconductor field-effect transistor (MOSFET) 24, and a resistor 25 used for current detection is connected between a positive terminal of a battery 21 and ground. For example, the DC motor 23 may be used for an air conditioner blower motor, a door lock actuator, and a power window actuator.

An input signal-processing unit 26 processes a drive control signal S1 output from, for example, an air conditioner electronic control unit (ECU) for air conditioning control and a door ECU (not shown) for opening, closing, locking, and unlocking a door of a vehicle. The drive control signal S1 output from such an ECU is a PWM signal having a carrier frequency of approximately 5 kHz, for example. The input signal-processing unit 26 performs frequency to voltage (FN) conversion in which the PWM signal is converted to a voltage signal, for example, through a filter. The input signal-processing unit 26 generates a drive command signal based on the converted voltage signal and outputs the drive command signal to the control circuit 27.

The control circuit 27 generates a PWM signal having a carrier frequency of, for example, approximately 20 kHz, and outputs a gate-drive signal to the gate of the MOSFET 24. The MOSFET 24 controls a voltage applied to the DC motor 23 in accordance with a level of the gate-drive signal. A flywheel diode 31 is connected in parallel with the motor 23 in a reverse-biased manner. A voltage monitor 28 monitors a drain voltage the MOSFET 24 (i.e., voltage of a terminal VM(−) of the DC motor 23) and outputs a monitor signal corresponding to the drain voltage to the control circuit 27. While monitoring the drain voltage by using the monitor signal, the control circuit 27 performs feedback control that allows the voltage applied to the motor 23 to be a target value.

A current monitor 29 has input terminals connected across the resistor 25. The current monitor 29 detects an electric current flowing through the resistor 25 based on voltage across the resistor 25 and outputs a detection signal corresponding to the detected current to a protection circuit 30. The protection circuit 30 performs a function of protecting the MOSFET 24 based on the detection signal. For example, when the motor 23 is locked and the detected current exceeds a threshold value, the protection circuit 30 outputs a protection command signal to the control circuit 27. In response to the protection command signal, the control circuit 27 controls the MOSFET 24 in such a manner that the voltage applied to the DC motor 23 is reduced. Thus, current flow is adjusted.

In FIG. 7, one DC motor 23 is connected in a low side drive configuration such that the terminal VM (−) of the DC motor 23 is connected to ground through the MOSFET 24 and the resistor 25. When multiple DC motors 23 are connected in the low side drive configuration, the control circuit 27 can output multiple PWM signals in accordance with the drive control signal S1 output from the ECU in such a manner that it is less likely that all the DC motors 23 are simultaneously driven.

(Second Application)

As the second application of the above embodiments, as shown in FIG. 8, a control circuit 32 is used for driving the DC motor 23 mounted to a vehicle, similarly to the control circuit 27 of FIG. 7.

In FIG. 8, one DC motor 23 is connected in a high side drive configuration such that a terminal VM (+) of the DC motor 23 is connected to a power voltage+B through the MOSFET 24 and the resistor 25. When multiple DC motors 23 are connected in the high side drive configuration, the control circuit 32 can output multiple PWM signals in accordance with the drive control signal S1 output from the ECU in such a manner it is less likely that all the DC motors 23 are simultaneously driven.

The above embodiments may be modified in various ways. For example, the control circuit 16 may be configured such that a load current of the load 7B driven by the inverted PWM signal PB is one-half of the sum of load currents of each of the three loads 7A-7C. In short, the control circuit 16 may be configured such that the sum of load currents flowing through each of loads simultaneously driven by the inverted PWM signals is one-half of the sum of load currents of each of all the loads in the load drive apparatus. In such an approach, consumption of the load current is equalized so that the increase in peak values of noise and heat production can be prevented.

The drive signal may be a signal provided as monopulse at a predetermined timing.

The present invention can be applied to a load drive apparatus for driving various types of electric loads including the linear solenoid and the DC motor 23.

Such changes and modifications are to be understood as being within the scope of the present invention as defined by the appended claims.

What is claimed is:

1. A load drive apparatus for driving at least two loads, comprising:
at least two switching devices connected to the loads to drive the loads, respectively; and
a drive signal control circuit for generating at least two drive signals for the switching devices at a same predetermined frequency, the drive signal control circuit including means for changing timing of generating the drive signals so that both of the drive signals do not overlap with respect to time.

2. The load drive apparatus according to claim 1, wherein
the drive signal control circuit changes a phase of at least one of the drive signals.

3. The load drive apparatus according to claim 2, wherein
the drive signal control circuit changes the phase of the drive signals in accordance with the number of the loads to equalize a phase difference between each of the drive signals.

4. The load drive apparatus according to claim 1, wherein
the drive signals are pulse-width modulation signals, and the drive signal control circuit generates each of the pulse-width modulation signals based on a same carrier wave signal.

5. The load drive apparatus according to claim 4, wherein
the drive signal control circuit inverts a phase of the carrier wave signal of at least one of the pulse-width modulation signals to invert a phase of the at least one of the pulse-width modulation signals.

6. The load drive apparatus according to claim 5, wherein
a sum of load currents flowing through the loads that are simultaneously driven by the inverted pulse width modulation signals is approximately one-half of a sum of load currents of each of all the loads driven in the load drive apparatus.

7. The load drive apparatus according to claim 1, wherein
at least one of the drive signals drives a linear solenoid.

8. The load drive apparatus according to claim 2, further comprising:
a delay circuit for delaying a phase of the drive signals to change the phase thereof; and
at least two output circuits for outputting the drive signals to the loads, wherein the delay circuit is connected between each of the output circuits.

9. The load drive apparatus according to claim 5, further comprising:
an inverting circuit for inverting the phase of the carrier wave signal to change the phase thereof; and
at least two output circuits for outputting the drive signals to the loads, wherein the inverting circuit is connected to between at least one pair of the output circuits.

10. A load drive method for driving at least two loads, comprising:
generating at least two drive signals to drive the loads at a same predetermined frequency; and
changing timing of generating the drive signals to prevent the generated drive signals from overlapping each other with respect to time.

11. The load drive method according to claim 10, wherein
the changing step changes a phase of at least one of the drive signals.

12. The load drive method according to claim 11, wherein
the changing step changes the phase of the drive signals in accordance with the number of the loads to equalize a phase difference between each of the drive signals.

13. The load drive method according to claim 10, wherein
the drive signals are pulse-width modulation signals, and the generating step generates each of the pulse-width modulation signals based on a same carrier wave signal.

14. The load drive method according to claim 13, wherein
the changing step inverts a phase of the carrier wave signal of at least one of the pulse-width modulation signals to invert a phase of the at least one of the pulse-width modulation signals.

15. The load drive method according to claim 14, wherein
a sum of load currents flowing through the loads that are simultaneously driven by the inverted pulse-width modulation signals is approximately one-half of a sum of load currents of each of all the loads driven in the load drive apparatus.

16. The load drive method according to claim 10, wherein
at least one of the drive signals drives a linear solenoid.
